(19) United States
(12) Patent Application Publication
(10) Pub. No.: US 2010/0293365 A1
(43) Pub. Date: Nov. 18, 2010

(54) METHOD AND APPARATUS FOR SYSTEM AND SOFTWARE QUICK LAUNCH

(75) Inventor: Vinod Vijay Tandon, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignee: SONY COMPUTER ENTERTAINMENT AMERICA INC., Foster City, CA (US)

(21) Appl. No.: 12/466,223

(22) Filed: May 14, 2009

(51) Int. Cl. G06F 9/24; G06F 9/44; G06F 3/048; A63F 9/24

(52) U.S. Cl. 713/2; 717/121; 715/810; 463/1

(57) ABSTRACT

A method includes launching a software application having a standard start-up mode, determining whether or not a set of application launch settings have been saved for the software application, running the software application in an alternative start-up mode if the set of application launch settings have been saved, and displaying images that are generated by a main portion of the software application. Another method includes begin performing a booting-up of a processor based system, determining whether or not a set of system launch settings have been saved, reading the set of system launch settings to determine an identity of a software application that should be automatically launched if the set of system launch settings have been saved, and automatically initiating a launching of the software application. A system and one or more computer programs are adapted to cause a processor based system to execute the above steps.

### BACKGROUND OF THE INVENTION

1. Field of the Invention

The present invention relates generally to computer software applications, and more specifically to the launching of computer software applications.

2. Discussion of the Related Art

Computer games, such as video games, have become a popular source of entertainment. Computer games are typically implemented in computer software applications and are often run on game consoles and entertainment systems. Before game play begins, a user often views one or more menu screens and makes selections, such as for example the type of character, the difficulty level of the game, etc.

### SUMMARY OF THE INVENTION

One embodiment provides a computer readable storage medium storing one or more computer programs adapted to cause a processor based system to execute steps comprising: launching a software application having a standard start-up mode that displays one or more initial loading screens prior to execution of a main portion of the software application; determining whether or not a set of application launch settings have been saved for the software application; if the set of application launch settings have been saved for the software application, running the software application in an alternative start-up mode that does not display at least one of the initial loading screens prior to execution of the main portion of the software application; and displaying images that are generated by the main portion of the software application on a display.

Another embodiment provides a method, comprising: launching a software application having a standard start-up mode that displays one or more initial loading screens prior to execution of a main portion of the software application; determining whether or not a set of application launch settings have been saved for the software application; if the set of application launch settings have been saved for the software application, running the software application in an alternative start-up mode that does not display at least one of the initial loading screens prior to execution of the main portion of the software application; and displaying images that are generated by the main portion of the software application on a display.

Another embodiment provides a computer readable storage medium storing one or more computer programs adapted to cause a processor based system to execute steps comprising: begin performing a booting-up of the processor based system; determining whether or not a set of system launch settings have been saved; if the set of system launch settings have been saved, reading the set of system launch settings to determine an identity of a software application that should be automatically launched; and automatically initiating a launching of the software application; wherein the software application includes a quick launch mode that is controlled by a set of application launch settings.

Another embodiment provides a method, comprising: begin performing a booting-up of a processor based system; determining whether or not a set of system launch settings have been saved; if the set of system launch settings have been saved, reading the set of system launch settings to determine an identity of a software application that should be automatically launched; and automatically initiating a launching of the software application; wherein the software application includes a quick launch mode that is controlled by a set of application launch settings.

A better understanding of the features and advantages of various embodiments of the present invention will be obtained by reference to the following detailed description and accompanying drawings which set forth an illustrative embodiment in which principles of embodiments of the invention are utilized.

### BRIEF DESCRIPTION OF THE DRAWINGS

The above and other aspects, features and advantages of embodiments of the present invention will be more apparent from the following more particular description thereof, presented in conjunction with the following drawings wherein:

FIG. 1 is a flow diagram illustrating a method in accordance with an embodiment of the present invention;

FIGS. 2A and 2B are flow diagrams illustrating and comparing a standard start-up mode and alternative start-up mode in accordance with an embodiment of the present invention;

FIG. 3 is a flow diagram illustrating additional and optional method steps in accordance with an embodiment of the present invention;

FIGS. 4A and 4B are flow diagrams illustrating a method in accordance with an embodiment of the present invention; and

FIG. 5 is a block diagram illustrating a computer or other processor based system that may be used to run, implement and/or execute the methods and techniques shown and described herein in accordance with the embodiments of the present invention.

### DETAILED DESCRIPTION

Many computer games and other computer software applications require a user (or player) to sit through a series of studio and game logos when the user first starts the game. That is, a user will typically need to view a title screen, logo screen, studio screen, license splash screen, etc., before the game puts the user in a main menu screen. Once in the main menu screen, the user will then need to make one or more selections, such as for example the type of character, the difficulty level of the game, etc. Many games require that a user make selections from more than one menu screen. After making the required selections, the user can then get into the game and commence with game play. This scenario often applies to both online and offline games.

Some of the embodiments of the present invention allow a user to specify his or her online and offline preferences for a computer game or other computer software application. Then whenever the game disc (or hard disk drive (HDD) downloadable game) is launched it automatically reads those preferences and puts the user directly into the game without displaying some or all of the initial loading screens, such as the above-mentioned title screens, logo screens, studio screens, license splash screens, menu screens, etc.

For example, in accordance with an embodiment of the present invention, one of the menu screens of a game or other software application includes an option for “Quick Launch” settings for the game or other software application. In some embodiments the option for “Quick Launch” settings may be displayed on a main menu screen. By way of example, for an online first person shooter game, a user could specify in the “Quick Launch” settings a favorite game room or game mode to search for. The next time the game is launched it would skip some or all of the initial loading screens and automatically log the user in, search for his or her game, and then put the user into the game. It is believed that many users would have a more satisfying experience by being put directly into the game or other application without having to view some or all of the initial loading screens.

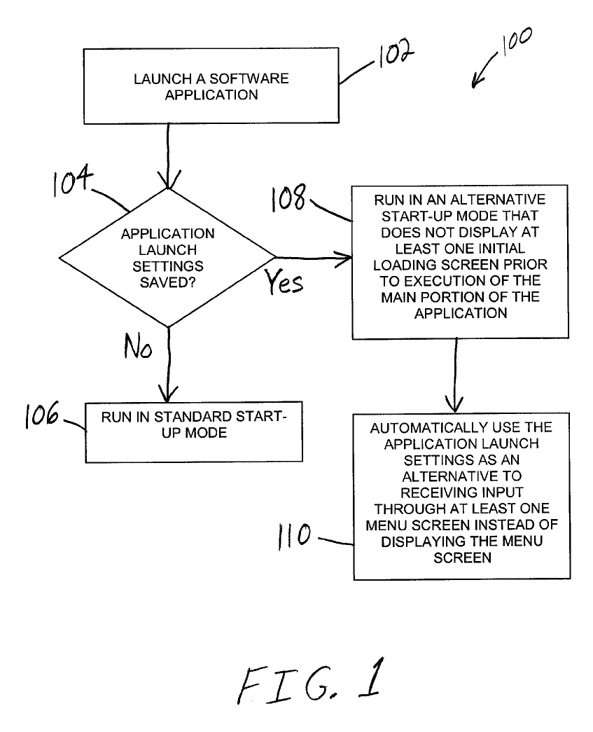

Referring to FIG. 1, there is illustrated an example of a method 100 in accordance with an embodiment of the present invention. The method 100 may be used for implementing a “Quick Launch” feature as described above. Furthermore, the method 100 may be applied to both online game types as well as offline game types.

The method 100 begins in step 102 in which a software application, such as a computer game, is launched. As will be described below, the software application typically includes a standard start-up mode that displays one or more initial loading screens prior to execution of a main portion of the software application.

In step 104 the system determines whether or not a set of application launch settings have been saved for the software application. In some embodiments, the set of application launch settings may be referred to as “Quick Launch” settings for the application. If a set of application launch settings have not been saved, then the system proceeds to step 106 where the software application is run in standard start-up mode.

On the other hand, if a set of application launch settings have been saved for the software application, then the system proceeds to step 108 where the software application is run in an alternative start-up mode. In some embodiments, the alternative start-up mode may be referred to as a “Quick Launch” mode.

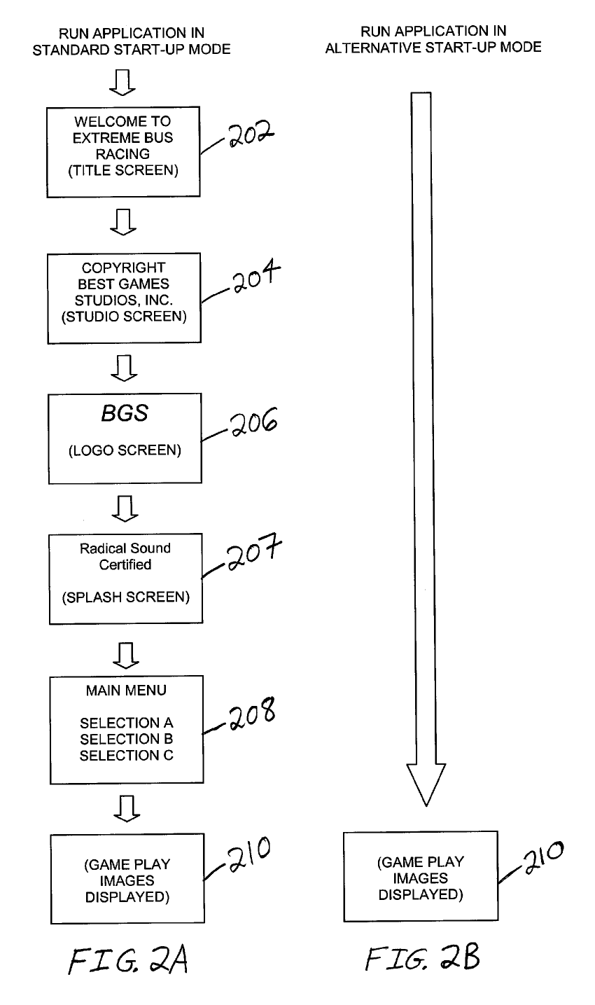

FIGS. 2A and 2B illustrate and compare embodiments of a standard start-up mode and alternative start-up mode, respectively. As mentioned above, in the standard start-up mode (FIG. 2A) the software application typically displays one or more initial loading screens prior to execution of a main portion of the software application. For example, in some embodiments a title screen 202 may be displayed to display the title of the software application, which in the illustrated example is “Extreme Bus Racing”. In some embodiments, a studio screen 204 may be displayed to display the name of the studio or company that developed the software application, which in the illustrated example is “Best Games Studios, Inc.” In some embodiments, a logo screen 206 may be displayed to display a logo for the studio or the software application, which in the illustrated example is “BGS”. And in some embodiments, a splash screen 207 may be displayed. For example, a license splash screen may be displayed for displaying any necessary information relating to software license agreements or other agreements, such as for using a specified audio/physics software library or the like. In the illustrated example, the splash screen 207 indicates that the software application is “Radical Sound Certified”, which may mean that a license has been obtained to use audio software referred to as “Radical Sound”. Other types of legal information may also be included on the splash screen or on other splash screens.

After the displaying of a title screen, studio screen, logo screen, and/or splash screen, one or more menu screens 208 are then displayed. As mentioned above, the menu screens are provided so that the user can choose his or her preferences for the game or other software application by making one or more selections. For example, the user can use the menu screens to select items such as the type of character, the difficulty level of the game, the race course for the game, the uniforms to be worn by the players in the game, etc.

After making the required menu selections, game play commences and the user proceeds to play the game or otherwise operate the software application. As such, the game play images begin being displayed, as indicated by display screen 210. That is, the images that are generated by the main portion of the software application are displayed on a display, which is represented by display screen 210. In some embodiments, the main portion of the software application is the portion of the application after the initial loading screens where a main purpose of the software application is being performed, which for example may be that actual game play.

Therefore, in the standard start-up mode the software application typically displays one or more initial loading screens prior to execution of a main portion of the software application. In some embodiments, the initial loading screens may comprise screens such as title screens, studio screens, logo screens, splash screens, menu screens, etc.

In the alternative start-up mode (FIG. 2B) the software application does not display at least one of the initial loading screens prior to execution of the main portion of the software application. Instead, the displaying of one or more of the initial loading screens is bypassed so that the software application can begin running the main portion of the software application more quickly. In the illustrated example, all of the initial loading screens, including the title screen 202, studio screen 204, logo screen 206, splash screen 207, and menu screens 208, are bypassed, which results in game play commencing and the game play images 210 being displayed much more quickly. As illustrated, the system proceeds directly to the display screen 210 which displays the actual game play images. The initial loading screens 202, 204, 206, and 208 are not displayed. Therefore, one reason that the software application is launched more quickly in the alternative start-up mode is because at least one of the initial loading screens is not displayed prior to execution of the main portion of the software application. Again, in some embodiments, the alternative start-up mode may be referred to as a “Quick Launch” mode.

Another reason that the software application is launched more quickly in the alternative start-up mode can be described as follows. Returning to the method 100 (FIG. 1), in some embodiments the running of the software application in the alternative start-up mode further comprises step 110. In step 110, at least a portion of the set of application launch settings are automatically used as an alternative to receiving input through at least one menu screen. That is, instead of a user manually making selections from a displayed menu screen, the set of application launch settings already include the user's selections and those selections are automatically provided to the software application as part of the alternative start-up mode. In some embodiments, this may be implemented in a macro or similar routine that automatically navigates the menus for the user and provides the user's preferred input selections to the menus. Again, the user's preferred input selections were previously saved in the application launch settings. This means that the menu screen does not have to be displayed, and so the displaying of the menu screen is bypassed. Thus, in some embodiments, a method to bypass at least one form of user input is also provided. For example, in some embodiments, if a set of application launch settings have been saved for the software application, the software application is run in an alternative start-up mode that does not display at least one of the initial loading screens, and/or that bypasses the taking of at least one set of user inputs, prior to execution of the main portion of the software application.

The set of application launch settings may include the user's selections of many different types of options. For example, in some embodiments the method allows the user to set his or her preference of “Quick Launching” an offline game or an online game. By way of example, possible offline game quick launch options may include a preference to load the latest saved game and automatically put the user in the game, a preference to select a certain character if the offline game offers different characters, or any other preferences and options. Possible online game quick launch options may include a preference to automatically search for the same game type as the user's last online game, a preference to automatically launch into a game that any of the user's buddies (on the user's buddy list) are located in, a preference to automatically launch into a dedicated game room and/or staging lobby before getting in the game, a preference to automatically create a new online multiplayer game and get in that game, or any other preferences and options. Other possible quick launch options may include launching the game or other software application at a certain time, or on a certain schedule, or calendaring the launch time, which could help in automatically launching a game tournament. That is, in some embodiments launching at a specific time may be useful for game tournaments that require the user to play at a certain time.

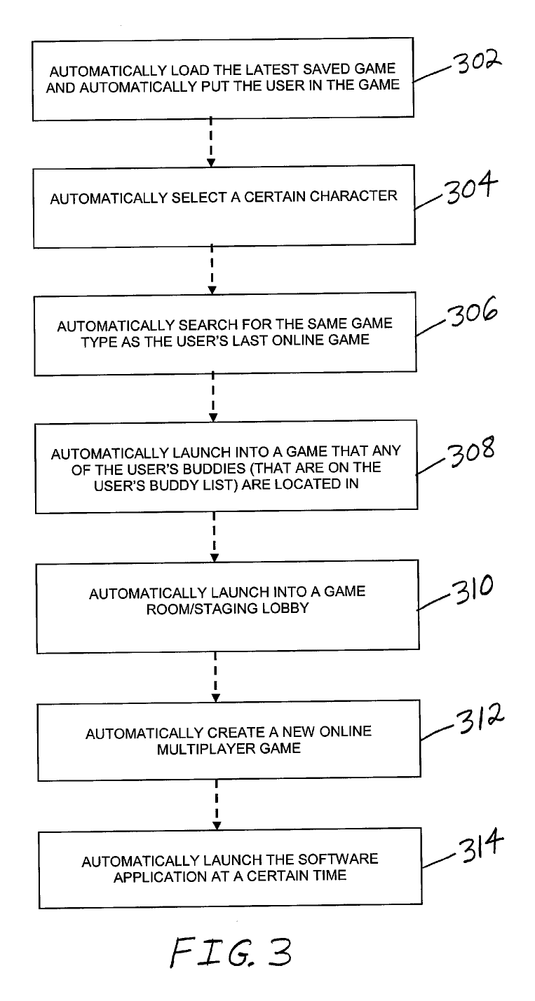

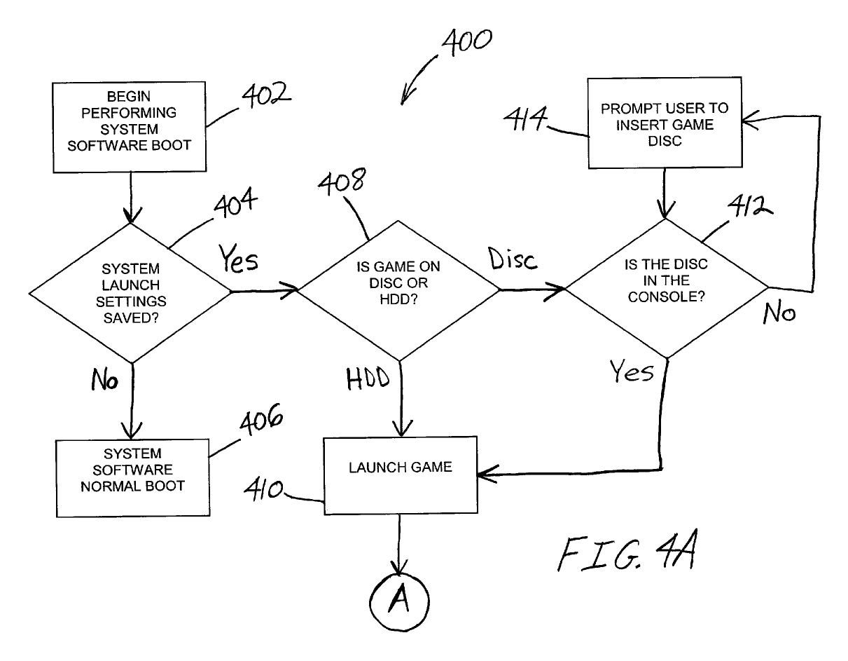

FIG. 3 illustrates the above-mentioned examples of options that the set of application launch settings can be configured to perform automatically. Several of the illustrated options are items that would normally be selected by a user on a menu screen. Because such items are configured automatically by the application launch settings in the alternative start-up mode, the corresponding menu screen is not displayed. It should be understood that each of the illustrated options are optional and are not required to be used and that many other options may alternatively be used.

Furthermore, each of the options are for the scenario where the software application comprises a game application, or the software application comprises an application for an online game. It should be well understood, however, that the software application may comprises any other type of application.

In step 302 the set of application launch settings causes the alternative start-up mode to automatically load the latest saved game and automatically put the user in the game. This saves the user from having to manually select the saved game, and it also means that the corresponding menu screen does not have to be displayed. Thus, the game can be launched faster.

In step 304 the set of application launch settings causes the alternative start-up mode to automatically select a certain character. Again, the user does not have to manually select the character and the corresponding menu screen does not have to be displayed, resulting in the game being launched faster.

Steps 306, 308, 310 and 312 assume that the software application comprises an application for an online game. Specifically, in step 306 the set of application launch settings causes the alternative start-up mode to automatically search for the same game type as a user's last online game. In step 308, the set of application launch settings causes the alternative start-up mode to automatically launch into a game that any of the user's buddies (that are on the user's buddy list) are located in. In step 310, the set of application launch settings causes the alternative start-up mode to automatically launch into a game room and/or staging lobby. And in step 312, the set of application launch settings causes the alternative start-up mode to automatically create a new online multiplayer game. Similar to above, with these options being automatically configured the user does not have to manually select the items and the corresponding menu screens do not have to be displayed, resulting in the game being launched faster.

In step 314 the set of application launch settings causes the alternative start-up mode to automatically launch the software application at a certain time. For example, in some embodiments the set of application launch settings may be configured or set so that the game or other software application is launched automatically at a certain time, or on a certain schedule. For example, the application launch settings may be set so that after the user exits the software application, the software application is then automatically launched at a certain time. Thus, in some embodiments the user may calendar a launch time in the set of application launch settings. As mentioned above, automatically launching at a specific time may be helpful in automatically launching game tournaments that require users to play at a certain time.

Again, the options 302, 304, 306, 308, 310, 312 and 314 are optional and are not required to be used, and any one or more of the options may be used in any combination.

In some embodiments, load balancing is employed for automatically launching into a certain online game, server, or a certain game room and/or staging lobby, such as with step 310. Load balancing is employed because too many users may have their application launch settings configured to launch into the same game, game room, etc. In some embodiments, the load balancing includes a randomness component to send some users to other games, servers, game rooms, etc., to avoid overloading any one game, server, or game room. Thus, load balancing the quick launch requests is used in some embodiments to prevent too many users from going to the same server and overloading it. In these embodiments, the load balancing serves as a restriction or limitation to allowing users to search for any game, server, or room that they want. That is, load balancing serves as a limitation to how closely a user's preferred criteria is matched.

In some embodiments, the above-described features are further expanded to include “Quick Launch” settings inside a game console's system software so that whenever a game console is turned on, a certain game is automatically launched with the game's internal “Quick Launch” settings. Such settings are referred to herein as system “Quick Launch” settings, or simply system launch settings.

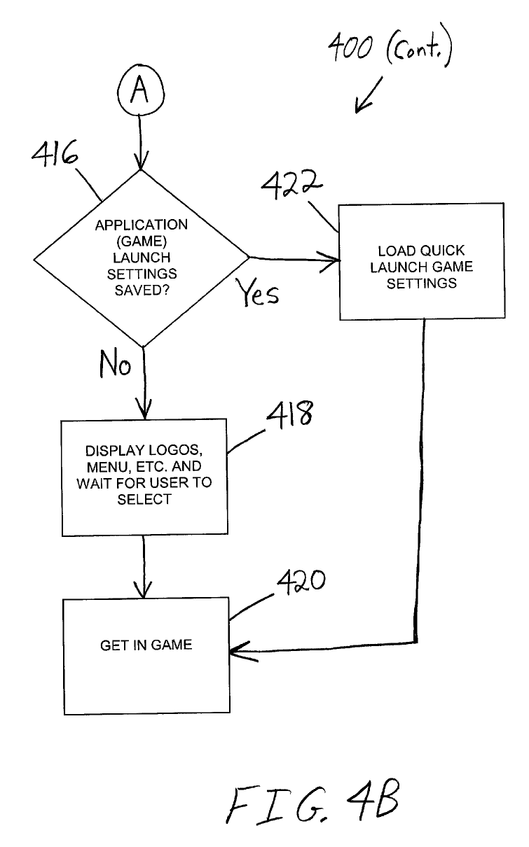

Referring to FIGS. 4A and 4B, there is illustrated an example of a method 400 in accordance with an embodiment of the present invention. The method 400 illustrates an example of the use of system launch settings. The method 400 begins in step 402 in which a processor based system begins performing the process of booting-up. In step 404, the system determines whether or not a set of system launch settings have been saved. The set of system launch settings identifies one or more software applications, such as computer games, that should be automatically launched at the time of booting-up. The software applications may either be offline or online applications, such as offline or online games. If a set of system launch settings have not been saved, the system proceeds with a normal boot as indicated by step 406.

If a set of system launch settings have been saved, the system reads the set of system launch settings to determine the identity of any software applications that should be automatically launched at the time of booting-up. When such a software application is identified, the system automatically initiates a launching of the software application.

In some embodiments, as part of the process of automatically initiating the launching of the software application, the system detects whether or not the software application is stored in a memory that is currently accessible by the processor based system. If the software application is not stored in a memory that is currently accessible by the processor based system, the system prompts the user to provide the processor based system with access to a memory that stores the software application.

For example, in step 408 the system detects whether the game or other application to be launched is located on the system's hard disc drive (HDD) or on disc. If the game is located on the HDD, the game is launched in step 410. If the game is located on disc, the system proceeds to step 412 where it detects whether or not the particular game disc is in the game console. If so, the game is launched in step 410. But if the particular game disc is not in the game console, the system prompts the user to insert the game disc in step 414.

After the game or other software application is launched in step 410, the system proceeds to step 416 (FIG. 4B). In step 416, the system determines whether or not a set of application launch settings have been saved for the game that has been launched. As described above, the game has a standard start-up mode that displays one or more initial loading screens prior to execution of a main portion of the game, and the game has an alternative start-up mode that does not display at least one of the initial loading screens prior to execution of the main portion of the game.

If a set of application launch settings have not been saved for the game, the game proceeds to step 418 where it is run in standard start-up mode. That is, the initial loading screens, such as studio screens, logos, menus, etc., are displayed and the game waits for the user to manually make selections. After the user makes all the required selections, the game play begins and the user is able to get in the game in step 420.

If a set of application launch settings have been saved for the game, the game proceeds to step 422 where the set of application launch settings are loaded. The game is then run in the alternative start-up mode that does not display at least one of the initial loading screens prior to execution of the main portion of the software application. Furthermore, the game is automatically configured according to the user's preferences that are included in the set of application launch settings. That is, the set of application launch settings are automatically used as an alternative to receiving input through the corresponding menu screens. This means that the corresponding menu screens are not displayed (i.e. they are bypassed) and the user is able to commence with game play and get in the game in step 420 more quickly than in the standard start-up mode.

Thus, some of the embodiments of the present invention allow a user to set and save application launch settings for a software application, such as a computer game. When such application launch settings have been saved, the software application is run in an alternative start-up mode that does not display at least one of the initial loading screens prior to execution of the main portion of the software application. In some embodiments, the initial loading screens may comprise title screens, logo screens, studio screens, splash screens, credit screens, menu screens, main menu screens, etc. In some embodiments, the game is automatically configured according to the user's preferences that are included in the application launch settings. This allows the user to avoid having to manually make selections from menu screens and manually get in the game or other software application as is believed to be required in conventional computer games. In some embodiments, the automatic configuring may be implemented in one or more macros or similar routines that automatically navigate the menus for the user and provide the user's preferred input selections to the menus. The above-described quick launch settings allow a user to automatically get in a game and commence with game play. Furthermore, the above-described method, features and techniques may be applied to both offline and online games and software applications.

In some embodiments, system “Quick Launch” settings may be saved to provide a method for system quick launch. The system launch settings identify one or more software applications, such as computer games, that should be automatically launched at the time of booting-up. Thus, when a processor based system such as a computer, game console, or entertainment system is turned on, a designated game or software application is automatically launched.

The application “Quick Launch” mode may be implemented in many different ways. For example, in some embodiments it may be implemented in one or more macros or similar routines or code that automatically navigate the menus of the software application for the user and provide the user's preferred input selections into the menus. In some embodiments, the user's control schemes are macroed into games that have predictable user interfaces. The macros provide a “Quick Launch” menu to the user so that the user can enter his or her preferences to set up the application launch settings. The macro implementation may be useful for existing or legacy games and other legacy software applications that were not originally designed to have a “Quick Launch” mode of operation. In some embodiments, a macro is considered a type of computer program.

In some embodiments, the software applications, such as computer games, may be designed according to a standard whereby they have a “Quick Launch” mode built into their code so that macros are not needed. This scheme is useful for new games and software applications that can be designed to follow the standard. Similar to above, a “Quick Launch” menu is provided to the user so that the user can enter his or her preferences to set up the application launch settings. By adhering to a standard, the criteria involved with setting up the “Quick Launch” mode will be consistent across different games and software applications.

Similarly, the system “Quick Launch” mode or feature may be implemented in many different ways. For example, in some embodiments it may be implemented in one or more macros or similar routines or code that initially ask the user which games or other software applications should be automatically launched. For example, the macro asks the user which game should be quick launched. The user provides his or her selections to the macro. Then, at the time of booting up, the macro is run and the designated games and/or software applications are automatically launched. The macro implementation may be useful for legacy operating systems that were not originally designed to have a system “Quick Launch” mode. Again, in some embodiments a macro is considered a type of computer program.

In some embodiments, the operating system for the computer, game console, entertainment system, or other processor based system, may be designed according to a standard whereby they have a system “Quick Launch” feature built into their code so that macros are not needed. The system initially asks the user via a menu which games or other software applications should be automatically quick launched. The standard is preferably compatible with the standard used for the application (or game) “Quick Launch” mode. This way the system “Quick Launch” feature will operate seamlessly with each software applications' individual application (or game) “Quick Launch” mode.

In some embodiments, the above-described methods, techniques, and features are applied to more than just computer software applications and computer games. For example, in some embodiments the above-described methods, techniques, and features are applied to online communities, virtual worlds and communities, and other online applications. The methods, techniques, and features may be used to automatically place a user into predesignated locations in an online community with the user's preferences being automatically configured according to a set of application launch settings. In this scenario the user is quickly placed into the online community without having to view the initial loading screens for the online community.

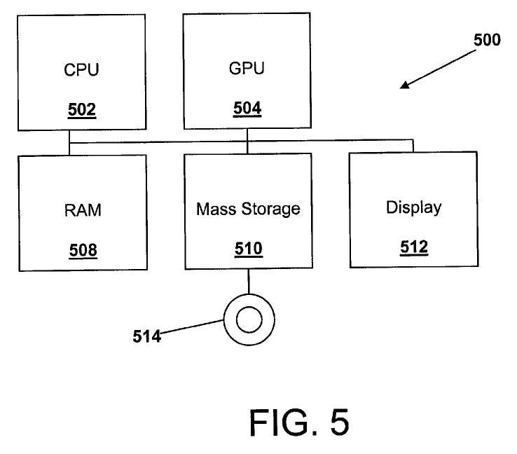

The methods and techniques described herein may be utilized, implemented and/or run on many different types of systems. Referring to FIG. 5, there is illustrated a system 500 that may be used for any such implementations. One or more components of the system 500 may be used for implementing any system or device mentioned above, such as for example any of the above-mentioned computers, game consoles, entertainment systems, etc. However, the use of the system 500 or any portion thereof is certainly not required.

By way of example, the system 500 may include, but is not required to include, a central processing unit (CPU) 502, a graphics processing unit (GPU) 504, a random access memory (RAM) 508, and a mass storage unit 510, such as a disk drive. The system 500 may be coupled to, or integrated with, any of the other components described herein, such as a display 512. The system 500 comprises an example of a processor based system. The CPU 502 and/or GPU 504 may be used to execute or assist in executing the steps of the methods and techniques described herein, and various program content, images, title screens, logo screens, studio screens, splash screens, credit screens, menu screens, main menu screens, etc. may be rendered on the display 512.

The mass storage unit 510 may include or comprise any type of computer readable storage or recording medium or media. The computer readable storage or recording medium or media may be fixed in the mass storage unit 510, or the mass storage unit 510 may optionally include removable storage media 514, such as a digital video disk (DVD), Blu-ray disc, compact disk (CD), USB storage device, floppy disk, or other media. By way of example, the mass storage unit 510 may comprise a disk drive, a hard disk drive, flash memory device, USB storage device, Blu-ray disc drive, DVD drive, CD drive, floppy disk drive, etc. The mass storage unit 510 or removable storage media 514 may be used for storing code or macros that implement the methods and techniques described herein.

Thus, removable storage media 514 may optionally be used with the mass storage unit 510, which may be used for storing code that implements the methods and techniques described herein, such as code for running the above-described alternative start-up mode and features. However, any of the storage devices, such as the RAM 508 or mass storage unit 510, may be used for storing such code. For example, any of such storage devices may serve as a tangible computer readable storage medium for storing or embodying a computer program for causing a console, system, computer, or other processor based system to execute or perform the steps of any of the methods, code, and/or techniques described herein. Furthermore, any of the storage devices, such as the RAM 508 or mass storage unit 510, may be used for storing any needed database(s).

In some embodiments, one or more of the embodiments, methods, approaches, and/or techniques described above may be implemented in a computer program executable by a processor based system. By way of example, such processor based system may comprise the processor based system 500, or a computer, entertainment system, game console, graphics workstation, etc. Such computer program may be used for executing various steps and/or features of the above-described methods and/or techniques. That is, the computer program may be adapted to cause or configure a processor based system to execute and achieve the functions described above. For example, such computer program may be used for implementing any embodiment of the above-described steps or techniques for quick launching a software application or system. As another example, such computer program may be used for implementing any type of tool or similar utility that uses any one or more of the above described embodiments, methods, approaches, and/or techniques. In some embodiments, the computer program may comprise a video game, role-playing game (RPG), other computer simulation, or system software such as an operating system, BIOS, macro, or other utility. In some embodiments, program code macros, modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein. For example, in some embodiments the present invention provides a computer readable storage medium storing one or more computer programs adapted to cause a processor based system to execute steps comprising: launching a software application having a standard start-up mode that displays one or more initial loading screens prior to execution of a main portion of the software application; determining whether or not a set of application launch settings have been saved for the software application; if the set of application launch settings have been saved for the software application, running the software application in an alternative start-up mode that does not display at least one of the initial loading screens prior to execution of the main portion of the software application; and displaying images that are generated by the main portion of the software application on a display.

As another example, in some embodiments the present invention provides a computer readable storage medium storing one or more computer programs adapted to cause a processor based system to execute steps comprising: begin performing a booting-up of the processor based system; determining whether or not a set of system launch settings have been saved; if the set of system launch settings have been saved, reading the set of system launch settings to determine an identity of a software application that should be automatically launched; and automatically initiating a launching of the software application; wherein the software application includes a quick launch mode that is controlled by a set of application launch settings.

While the invention herein disclosed has been described by means of specific embodiments and applications thereof, numerous modifications and variations could be made thereto by those skilled in the art without departing from the scope of the invention set forth in the claims.

What is claimed is:

1. A computer readable storage medium storing one or more computer programs adapted to cause a processor based system to execute steps comprising:
launching a software application having a standard start-up mode that displays one or more initial loading screens prior to execution of a main portion of the software application;
determining whether or not a set of application launch settings have been saved for the software application;
if the set of application launch settings have been saved for the software application, running the software application in an alternative start-up mode that does not display at least one of the initial loading screens prior to execution of the main portion of the software application; and
displaying images that are generated by the main portion of the software application on a display.

2. The computer readable storage medium of claim 1, wherein:
the one or more initial loading screens comprises at least one menu screen; and
the running the software application in an alternative start-up mode further comprises,
automatically using at least a portion of the set of application launch settings as an alternative to receiving input through the at least one menu screen; and
bypassing a displaying of the at least one menu screen.

3. The computer readable storage medium of claim 1, wherein:
the one or more initial loading screens comprises at least one of a title screen, logo screen, studio screen, and splash screen; and
the alternative start-up mode does not display at least one of the initial loading screens that comprises one of a title screen, logo screen, studio screen, and splash screen.

4. The computer readable storage medium of claim 1, wherein:
the software application comprises a game application; and
the set of application launch settings causes the alternative start-up mode to automatically load a latest saved game and automatically put a user in the game.

5. The computer readable storage medium of claim 1, wherein:
the software application comprises a game application; and
the set of application launch settings causes the alternative start-up mode to automatically select a certain character.

6. The computer readable storage medium of claim 1, wherein:
the software application comprises an application for an online game; and
the set of application launch settings causes the alternative start-up mode to automatically search for a same game type as a user's last online game.

7. The computer readable storage medium of claim 1, wherein:
the software application comprises an application for an online game; and
the set of application launch settings causes the alternative start-up mode to automatically launch into a game that any of a user's buddies that are on the user's buddy list are located in.

8. The computer readable storage medium of claim 1, wherein:
the software application comprises an application for an online game; and
the set of application launch settings causes the alternative start-up mode to automatically launch into a game room/staging lobby.

9. The computer readable storage medium of claim 1, wherein:
the software application comprises an application for an online game; and
the set of application launch settings causes the alternative start-up mode to automatically create a new online multiplayer game.

10. The computer readable storage medium of claim 1, wherein the set of application launch settings causes the alternative start-up mode to automatically launch the software application at a certain time.

11. The computer readable storage medium of claim 1, wherein the one or more computer programs are further adapted to cause the processor based system to execute steps comprising:
prior to the launching the software application, begin performing a booting-up of the processor based system;
determining whether or not a set of system launch settings have been saved; and
performing the launching of the software application automatically in response to the set of system launch settings indicating that the software application should be launched automatically.

12. A method, comprising:
launching a software application having a standard start-up mode that displays one or more initial loading screens prior to execution of a main portion of the software application;
determining whether or not a set of application launch settings have been saved for the software application;
if the set of application launch settings have been saved for the software application, running the software application in an alternative start-up mode that does not display at least one of the initial loading screens prior to execution of the main portion of the software application; and
displaying images that are generated by the main portion of the software application on a display.

13. The method of claim 12, wherein:
the one or more initial loading screens comprises at least one menu screen; and
the running the software application in an alternative start-up mode further comprises,
automatically using at least a portion of the set of application launch settings as an alternative to receiving input through the at least one menu screen; and
bypassing a displaying of the at least one menu screen.

14. The method of claim 12, wherein:
the one or more initial loading screens comprises at least one of a title screen, logo screen, studio screen, and splash screen; and
the alternative start-up mode does not display at least one of the initial loading screens that comprises one of a title screen, logo screen, studio screen, and splash screen.

15. The method of claim 12, wherein:
the software application comprises a game application; and
the set of application launch settings causes the alternative start-up mode to automatically load a latest saved game and automatically put a user in the game.

16. The method of claim 12, wherein:
the software application comprises a game application; and
the set of application launch settings causes the alternative start-up mode to automatically select a certain character.

17. The method of claim 12, wherein:
the software application comprises an application for an online game; and
the set of application launch settings causes the alternative start-up mode to automatically search for a same game type as a user's last online game.

18. The method of claim 12, wherein:
the software application comprises an application for an online game; and
the set of application launch settings causes the alternative start-up mode to automatically launch into a game that any of a user's buddies that are on the user's buddy list are located in.

19. The method of claim 12, wherein:
the software application comprises an application for an online game; and
the set of application launch settings causes the alternative start-up mode to automatically launch into a game room/staging lobby.

20. The method of claim 12, wherein:
the software application comprises an application for an online game; and
the set of application launch settings causes the alternative start-up mode to automatically create a new online multiplayer game.

21. The method of claim 12, wherein the set of application launch settings causes the alternative start-up mode to automatically launch the software application at a certain time.

22. The method of claim 12, further comprising:
prior to the launching the software application, begin performing a booting-up of a processor based system;
determining whether or not a set of system launch settings have been saved;
performing the launching of the software application automatically in response to the set of system launch settings indicating that the software application should be launched automatically.

23. A computer readable storage medium storing one or more computer programs adapted to cause a processor based system to execute steps comprising:
begin performing a booting-up of the processor based system;
determining whether or not a set of system launch settings have been saved;
if the set of system launch settings have been saved, reading the set of system launch settings to determine an identity of a software application that should be automatically launched; and
automatically initiating a launching of the software application;
wherein the software application includes a quick launch mode that is controlled by a set of application launch settings.

24. The computer readable storage medium of claim 23, wherein the automatically initiating a launching of the software application comprises:
detecting whether or not the software application is stored in a memory that is currently accessible by the processor based system.

25. The computer readable storage medium of claim 24, wherein the automatically initiating a launching of the software application further comprises:
if the software application is not stored in a memory that is currently accessible by the processor based system, prompting a user to provide the processor based system with access to a memory that stores the software application.

26. The computer readable storage medium of claim 23, wherein:
the software application has a standard start-up mode that displays one or more initial loading screens prior to execution of a main portion of the software application; and
the one or more computer programs are further adapted to cause the processor based system to execute a step comprising determining whether or not the set of application launch settings have been saved for the software application.

27. The computer readable storage medium of claim 26, wherein the one or more computer programs are further adapted to cause the processor based system to execute a step comprising:
if the set of application launch settings have been saved for the software application, running the software application in the quick launch mode, wherein the quick launch mode does not display at least one of the initial loading screens prior to execution of the main portion of the software application.

28. The computer readable storage medium of claim 27, wherein:
the one or more initial loading screens comprises at least one menu screen; and
the running the software application in the quick launch mode further comprises,
automatically using at least a portion of the set of application launch settings as an alternative to receiving input through the at least one menu screen; and
bypassing a displaying of the at least one menu screen.

29. The computer readable storage medium of claim 27, wherein:
the one or more initial loading screens comprises at least one of a title screen, logo screen, studio screen, and splash screen; and
the quick launch mode does not display at least one of the initial loading screens that comprises one of a title screen, logo screen, studio screen, and splash screen.

30. A method, comprising:
begin performing a booting-up of a processor based system;
determining whether or not a set of system launch settings have been saved;
if the set of system launch settings have been saved, reading the set of system launch settings to determine an identity of a software application that should be automatically launched; and
automatically initiating a launching of the software application;
wherein the software application includes a quick launch mode that is controlled by a set of application launch settings.

31. The method of claim 30, wherein the automatically initiating a launching of the software application comprises:
detecting whether or not the software application is stored in a memory that is currently accessible by the processor based system.

32. The method of claim 31, wherein the automatically initiating a launching of the software application further comprises:
if the software application is not stored in a memory that is currently accessible by the processor based system, prompting a user to provide the processor based system with access to a memory that stores the software application.

33. The method of claim 30, wherein:
the software application has a standard start-up mode that displays one or more initial loading screens prior to execution of a main portion of the software application; and
the method further comprises determining whether or not the set of application launch settings have been saved for the software application.

34. The method of claim 33, wherein the method further comprises:
if the set of application launch settings have been saved for the software application, running the software application in the quick launch mode, wherein the quick launch mode does not display at least one of the initial loading screens prior to execution of the main portion of the software application.

35. The method of claim 34, wherein:
the one or more initial loading screens comprises at least one menu screen; and
the running the software application in the quick launch mode further comprises,
automatically using at least a portion of the set of application launch settings as an alternative to receiving input through the at least one menu screen; and
bypassing a displaying of the at least one menu screen.

36. The method of claim 34, wherein:
the one or more initial loading screens comprises at least one of a title screen, logo screen, studio screen, and splash screen; and
the quick launch mode does not display at least one of the initial loading screens that comprises one of a title screen, logo screen, studio screen, and splash screen.
